(19) United States
(12) Patent Application Publication
(10) Pub. No.: US 2026/0148047 A1
(43) Pub. Date: May 28, 2026

(54) METHOD FOR TRAINING A SPIKING NEURAL NETWORK

(71) Applicants: Jean Michel SELLIER, Montreal (CA); TELEFONAKTIEBOLAGET LM ERICSSON (PUBL), Stockholm (SE)

(72) Inventor: Jean Michel SELLIER, Montreal (CA)

(73) Assignee: TELEFONAKTIEBOLAGET LM ERICSSON (PUBL), Stockholm (SE)

(21) Appl. No.: 19/121,899

(22) PCT Filed: Oct. 18, 2022
(86) PCT No.: PCT/IB2022/060005

§ 371 Date: Apr. 17, 2025

(51) Int. Cl. G06N 3/049

(52) U.S. Cl. CPC G06N 3/049

(57) ABSTRACT

The disclosure relates to an artificial spiking neural network building block, a spiking neural network, a method for training a spiking neural network, an apparatus and a non-transitory computer readable media. The computer implemented method comprises assigning random weights to all connections between spiking neurons of the spiking neural network. The method comprises iteratively optimizing the weights by running a simulated annealing algorithm, using training data. The method comprises refining the weights by running a genetic algorithm.

### TECHNICAL FIELD

The present disclosure relates to the training of spiking neural networks (SNNs).

### BACKGROUND

Present-day academic articles are conceptualizing sixth generation (6G) networks and the plethora of new features that they may embed. Artificial intelligence (AI) is planned to be included in many of these predictions, from 6G supporting AI infrastructure to “AI designing and optimizing 6G architectures, protocols, and operations”. These applications will require advanced AI and machine learning (ML) tools capable of dealing with extremely complex situations beyond our current reach. One promising direction to take, to obtain such sophisticated tools, is inspired by biological neural systems.

Consequently, there has been recent increasing interest in (deep) spiking neural networks (SNNs) made of artificial neurons with one or more dendrites and, possibly, with recurrent connections. This is a step closer to biological systems especially when compared to the mainstream AI approach which is, to a large extent, based on the concept of point-neuron and feedforward artificial neural networks (ANNs). These alternative models try to achieve an AI capable of mimicking natural intelligence. Some models in the art utilize spiking neurons in their approach with one or more dendrites, for different purposes, e.g., associative memories and in different shapes, e.g., implemented in hardware or software (although mainly in hardware). These approaches usually base the necessary training on Hebbian-like rules, and it is well known that (deep, recurrent) SNNs can be difficult to train.

### SUMMARY

In order to solve the above-described problem, an effective, parallelizable, and gradient-free training method for deep recurrent spiking artificial neural networks, made of neurons with one or more dendrites, is provided. There is provided an artificial spiking neural network building block, comprising two layers, each comprising two spiking neurons. Each spiking neuron comprises at least one feedback input connection, operative to receive spikes from at least one spiking neuron of a subsequent layer. Each spiking neuron comprises at least one feedback output connection, operative to transmit spikes to at least one spiking neuron of a preceding layer. Each spiking neuron comprises at least one feedforward input connection, operative to receive spikes from at least one spiking neuron of the preceding layer. Each spiking neuron comprises at least one feedforward output connection, operative to transmit spikes, from the spiking neuron, to at least one spiking neuron of the subsequent layer. Each spiking neuron comprises at least one contextual input connection, operative to receive spikes from at least one spiking neuron of a same layer. Each spiking neuron comprises at least one contextual output connection, operative to transmit spikes to at least one spiking neuron of the same layer. The input and output connections between the spiking neurons are operative to transmit or receive trains of spikes.

There is provided a spiking neural network comprising at least one input spiking neuron, at least one output spiking neuron, and at least one spiking neural network building block, as previously described, connected between the at least one input spiking neuron and the at least one output spiking neuron via feedforward connections.

There is provided a computer implemented method for training a spiking neural network. The method can apply to training any types or configurations of spiking neural networks comprising any number of spiking neurons. The method comprises assigning random weights to all connections between spiking neurons of the spiking neural network. The method comprises iteratively optimizing the weights by running a simulated annealing algorithm, using training data. The method comprises refining the weights by running a genetic algorithm.

There is provided an apparatus, operative to train a spiking neural network, comprising processing circuits and a memory, the memory containing instructions executable by the processing circuits. The apparatus is operative to assign random initial weights to all connections between spiking neurons of the spiking neural network. The apparatus is operative to iteratively optimize the weights by running a simulated annealing algorithm, using training data. The apparatus is operative to refine the weights by running a genetic algorithm.

There is provided a non-transitory computer readable media having stored thereon instructions for training a spiking neural network. The instructions comprise assigning random initial weights to all connections between spiking neurons of the spiking neural network. The instructions comprise iteratively optimizing the weights by running a simulated annealing algorithm, using training data. The instructions comprise refining the weights by running a genetic algorithm.

The spiking neural network building block, the spiking neural network, the method, the apparatus and the non-transitory computer readable media provided herein present improvements to the way spiking neural networks and training of spiking neural networks operate.

### BRIEF DESCRIPTION OF THE DRAWINGS

FIG. 1 is a schematic illustration of a basic bloc (or unit) of a neural network with surrounding spiking neurons.

FIGS. 2a-d are schematic illustrations of neural networks made of units of FIG. 1. FIG. 2a is a 1×2×2×1 neural network made of one unit of FIG. 1, FIG. 2b is a 1×2×2×2×1 neural network made of two connected units of FIG. 1, FIG. 2c is a 2×2×2×2 neural network made of one unit of FIG. 1 and FIG. 2d is a 3×4×4×4×2 neural network made of six units of FIG. 1.

FIGS. 3a-f are schematic illustrations of neural networks made with spiking neurons. FIG. 3a is a feed forward network made of two input cells, two hidden cells and one output cell, FIG. 3b is a deep feed forward network made of three input cells, eight hidden cells and two output cells, FIG. 3c is an auto encoder neural network made of four input cells, two hidden cells and four match input output cells, FIG. 3d is a recurrent neural network made of three input cells, six recurrent cells and three output cells, FIG. 3e is a deep convolutional network made of five input cells, five kernel cells, nine convolution or pool cells, eight hidden cells and three output cells and FIG. 3f is a Hopfield network made of eight fully connected back fed input cells.

FIG. 4 is a flowchart of a simulated annealing algorithm.

FIG. 5 is a flowchart of a genetic algorithm (GA).

FIGS. 6-9 are graphs illustrating results obtained using a 1×2×2×1 network according to FIG. 2 for fitting the function f(x)=x. FIGS. 6 to 9 correspond, respectively, to error/cost functions with values 0.15 (FIG. 6), 0.10 (FIG. 7), 0.05 (FIG. 8) and 0.01 (FIG. 9).

FIGS. 10-13 are graphs illustrating results obtained using a 1×2×2×1 network according to FIG. 2 for fitting the function f(x)=sqrt(x). FIGS. 10 to 13 correspond, respectively, to error/cost functions with values 0.15 (FIG. 10), 0.10 (FIG. 11), 0.05 (FIG. 12) and 0.01 (FIG. 13).

FIGS. 14-16 are graphs illustrating results obtained for fitting the quadratic function f(x)=x² using different network configurations. FIGS. 14 to 16 use, respectively, the following networks configurations: 1×2×2×1 (FIG. 14), 1×3×3×1 (FIG. 15) and 1×4×4×1 (FIG. 16).

FIG. 17 is a flowchart of a method for training a spiking neural network.

FIG. 18 is a schematic illustration of a hardware in which steps described herein can be executed.

FIG. 19 is a schematic illustration of a virtualization environment in which the steps, method and apparatus described herein can be deployed.

### DETAILED DESCRIPTION

Various features will now be described with reference to the drawings to fully convey the scope of the disclosure to those skilled in the art.

Sequences of actions or functions may be used within this disclosure. It should be recognized that some functions or actions, in some contexts, could be performed by specialized circuits, by program instructions being executed by one or more processors, or by a combination of both.

Further, computer readable carrier or carrier wave may contain an appropriate set of computer instructions that would cause a processor to carry out the techniques described herein.

The functions/actions described herein may occur out of the order noted in the sequence of actions or simultaneously. Furthermore, in some illustrations, some blocks, functions or actions may be optional and may or may not be executed; these are generally illustrated with dashed lines.

Herein, the expressions neural network (NN), artificial neural network (ANN) and spiking neural network (SNN) may be used interchangeably. In some contexts, an artificial neural network could include biological portions.

As previously stated, despite the high potential of SNNs, their training remains an open and complex problem. In fact, while in theory SNNs have been shown to be as computationally powerful as traditional ANNs, in practice they have not reached the same accuracy levels of traditional ANNs. The major reason for such a situation is represented by the lack of adequate training algorithms for deep SNNs, since spike signals are not differentiable.

To remedy the situation, a novel gradient-free robust to noise method is described herein, which allows the effective training of (deep) SNNs made of neurons with multi-dendrites and recurrent connections. The method is based on the adaptation of a simulated annealing (SA) method with a probabilistic interpretation of the connection weights.

To the best of the author's knowledge, this method is the very first gradient-free, stochastic method capable of training recurrent, deep SNNs with multi-dendrite neurons on digital computing devices. The method is based on the use of simulated annealing, which is known in the applied mathematics and physics communities, but was never used for training ANNs, especially deep recurrent SNNs.

The method is based on a statistical reinterpretation of the connection weights. This is in contrast with the state of the art, in which weights are usually considered as simple scalars.

The method for training recurrent SNNs presented herein has several important advantages over (non-recurrent, zero-point) traditional ANNs.
Parallelization: the method presented herein is parallelizable to a large degree, which represents an important advantage when it comes to training large, deep, and sophisticated SNNs.
Activation functions: unlike traditional ANNs, there is no need to choose/have an activation function for the neurons since the neurons are complex enough to mimic or emulate both linearities and non-linearities happening in biological neurons.
Data: the method presented herein is gradient-free and, therefore, allows the training phase over any kind of dataset (i.e., it does not require any specific mathematical assumption over the data in use).
Temporal patterns: SNNs are capable of recognizing temporal patterns, which is known to be a daunting task for traditional ANNs. Therefore, the method presented herein opens the way towards such applications.

### Model of a Neuron

The artificial neuron utilized to validate the training method suggested in this work has the following fundamental features:
the input and output of the neuron are represented by trains of spikes,
the neuron can have as many dendrites as needed, i.e., one or more.

More specifically, the first point indicates that a mathematical model for output spiking signals is chosen and utilized. Such a model is presented below and consists of the computationally tractable leaky fire-and-integrate model, which is slightly modified to mimic or emulate the presence of neural refractory periods (i.e., the neuron needs to recover for a certain time after a firing event). This is a drastic departure from the zero-point neuron which, instead, utilizes the concept of activation function. The selection of this mathematical model does not represent a limitation to the training method presented below. Any other method, such as, but not limited to, the Hodgkin-Huxley model, the Perfect integrate-and-fire model, the adaptive integrate-and-fire model and the spike response model could alternatively be utilized. The leaky fire-and-integrate model (LIF) model has been selected because of its simplicity and computational cost.

The second point of the list shows that the neural model should include the possibility of mathematically treating the presence of many dendrites (another departure from mainstream approaches). The interpretation of the weights as statistical probabilities (see below) helps to efficiently treat many dendrites attached to the same neuron.

### Mathematical Model of the Neuron

The model to describe the response of a neuron (i.e., its membrane voltage) which has received a current injection is represented by the LIF. This model can successfully mimic the behavior of the biological neuron with a minimum number of computational operations, unlike other (more detailed) models.

In particular, the LIF model represents a neuron as a parallel combination of a “leaky” resistor and a capacitor. A time-dependent current source I=I(t), what will be referred to herein as a train or sequence of spikes, is used as a synaptic current input to charge up the capacitor to produce a corresponding time-dependent membrane potential u=u(t). Mathematically, this model reads:

$${τ}_{m} \frac{d u ( t )}{d t} = RI ( t ) - ( u - {u}_{rest} ) ,$$

where τₘ is the membrane time constant (1 millisecond), R is the neuron internal resistance

$$R = \frac{{τ}_{m}}{C} ,$$

With C=0.92 microFarad/second, for example, being the neuron membrane capacitance) and uᵣₑₛₜ is the membrane potential at rest (uᵣₑₛₜ=−70 milliVolt, for example). The initial conditions for the variable u=u(t) are u(0)=uᵣₑₛₜ, in other words the membrane potential is at rest if no injected current is present. Herein, u(t) represents an output sequence, or output train, of spikes. This model can be simulated, in a discrete time fashion, by using the Euler method (see below for more details).

### Mathematical Model for the Refraction Period

Biological neurons are also known to experimentally show a refractory period right after a current has been injected and an output response signal has been triggered. In practice, this is the recovery time for an excitable neuron membrane to be ready for a subsequent stimulus once it returns to its resting state. This mechanism should not be ignored as it is relevant in biological neurons. Therefore, it is included into the mathematical model of an artificial neuron.

To include this mechanism in practical computations, after a neural spiking event has occurred the neuron should stay inactive for the whole duration of the refractory period (considered equal to 1 millisecond, for example). This can be achieved by keeping track or storing the time of firing and making sure that no other firing event happens in the amount of time specified as the refractory period.

### The Euler Method

The Euler method is an approach which allows to numerically integrate an ordinary differential equation (ODE). Supposing that the problem at hand reads:

$$\frac{d y ( t )}{d t} = f ( t , y ( t ) ) ,$$

with y=y(t) the unknown function to be found, ƒ=ƒ(t,y) a given function, and y=y(0) the initial conditions of the problem. By introducing the forward finite difference formula of the derivative which reads:

$$\frac{d y ( n \cdot Δ t )}{d t} \approx \frac{{y}^{n + 1} - {y}^{n}}{Δ t} ,$$

$$and where : {y}^{n} = y ( n \cdot Δ t ) ,$$

and Δt is the time step for the simulation, it is possible to obtain the following discretized method to simulate the LIF model:

$${y}^{n + 1} = {y}^{n} + Δ t \cdot f ( n \cdot Δ t , {y}^{n} ) .$$

The above formula is utilized recursively until the final time of the simulation (set to 1 second, for example) is reached. This long time (numerically) guarantees that a final stationary regime is reached.

### Dendrites and Weights

Mainstream models of artificial neurons in use today (i.e., zero-point neurons) assume that a neuron has only one dendrite with one or more synapses on it. Therefore, in practice, this model has a single set of weights assigned to it. Biological neurons, though, can have thousands of dendrites which serve the scope to make the neuron able to recognize an ensemble of different patterns rather than just one. Consequently, a reliable artificial neuron model should include such experimental observations. Herein, an artificial neuron can have an arbitrary number of dendrites which, in turn, can have an arbitrary number of synapses.

The way many dendrites are treated herein allows a computational treatment that does not become a bottleneck. The weights in the suggested approach are always positive real numbers which are interpreted probabilistically. Assuming the strength of a synapse is directly proportional to its size, a pseudo-random number r in the interval [0, 1] is generated every time a spike is passing through the synapse to decide if it goes through or not. In other words, if r<w (with w the weight, which has a value in the range [0, 1], corresponding to the synapses and to its strength) then the signal goes through, otherwise it does not. Then, every spike which passes this test is utilized to create a new train of spikes. This seems to simulate biological synapses well enough, according to available observations of biological synapses and their dimensions.

### Networks of Neurons

It is possible to create any sort of networks made of neurons such as the one described above. Herein, one family of (deep) structures (for curve fitting tests) and one specific architecture (for the Modified National Institute of Standards and Technology (MNIST) dataset—the MNIST dataset contains binary images of handwritten digits) are utilized to validate the suggested training method.

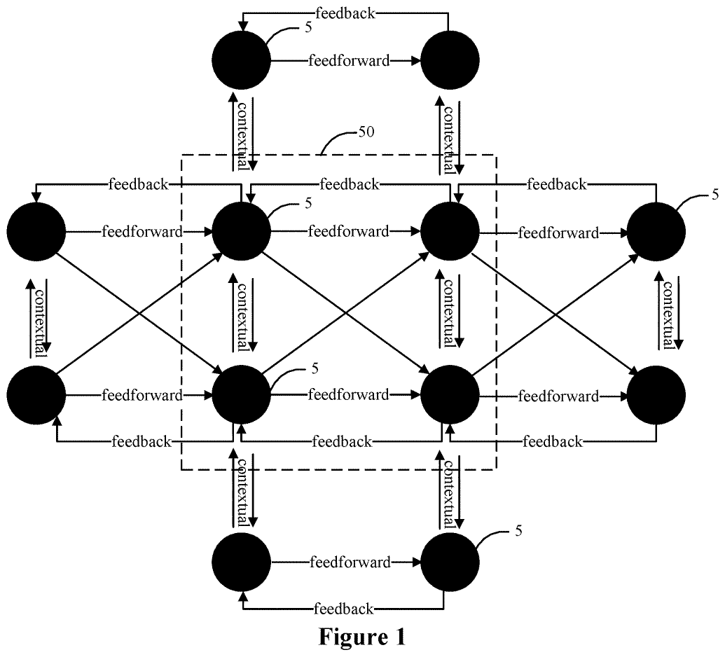

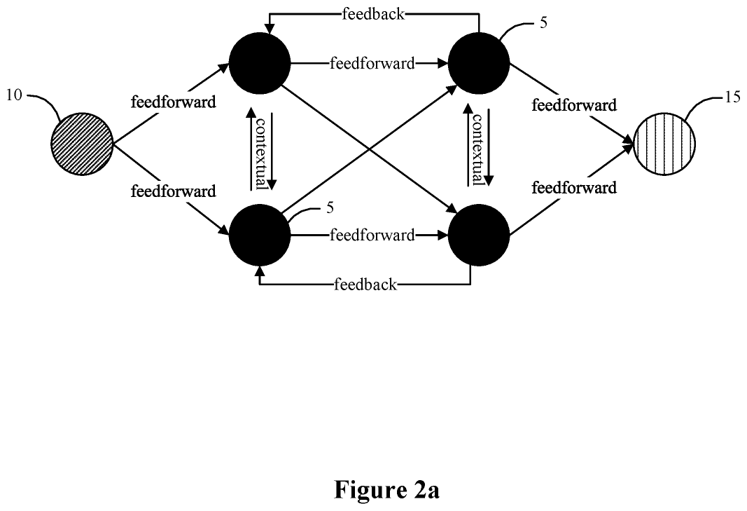

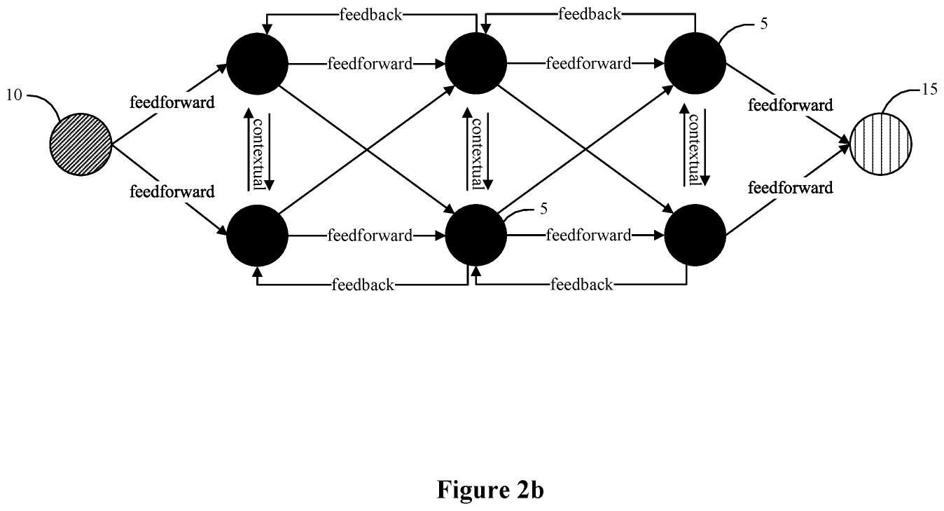

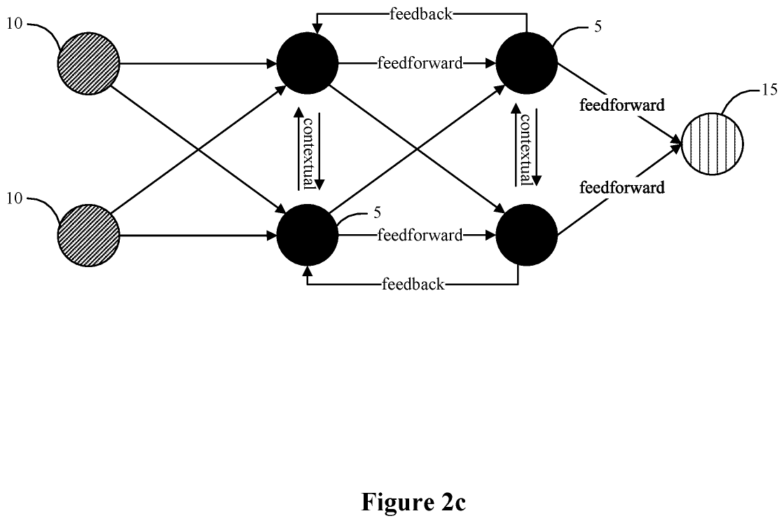

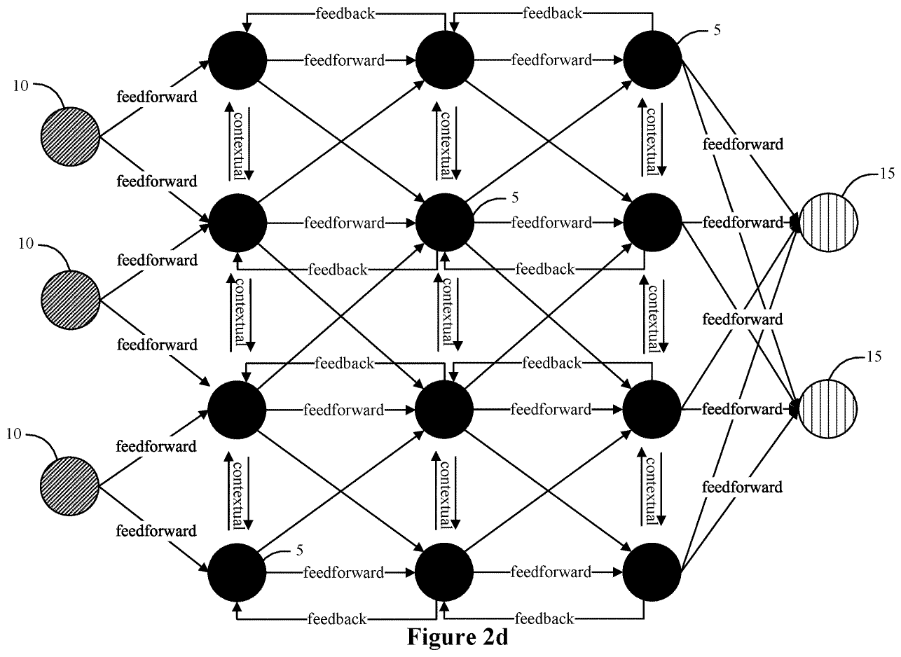

In the first family of structures, the basic network unit 50 for a neural network made of spiking neurons 5 with multi-dendrite is represented by the one depicted in FIG. 1. In this architecture, the dendrites can be classified, depending on their position/function, in feedforward, contextual and feedback dendrites. In practice, the feedforward information travels from left to right, while the feedback information travels from right to left and the contextual information travels from top to down and from down to top. Contextual information provides information concerning previous states of the neural network. It is possible to connect different units 50 with each other and some examples are shown in FIGS. 2a-d. FIG. 2a is a 1×2×2×1 neural network made of one unit 50 of FIG. 1, FIG. 2b is a 1×2×2×2×1 neural network made of two connected units 50 of FIG. 1, FIG. 2c is a 2×2×2×2 neural network made of one unit 50 of FIG. 1 and FIG. 2d is a 3×4×4×4×2 neural network made of six units 50 of FIG. 1.

Each unit 50 is generally made of four spiking neurons 5.

It should be noted that it is possible to train other kinds of networks with the method described herein. The networks illustrated in the figures do not represent a limitation of the training method.

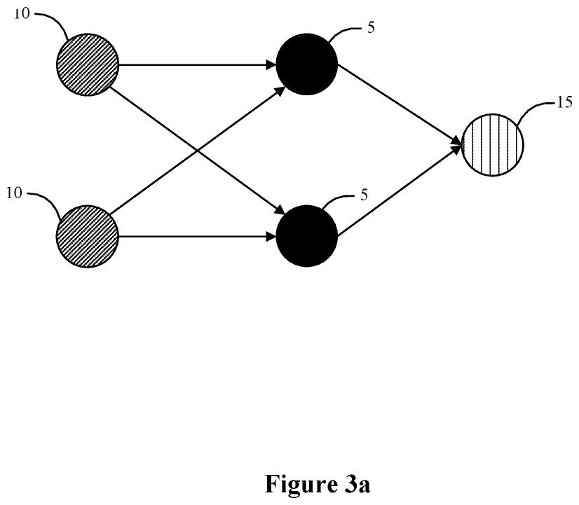

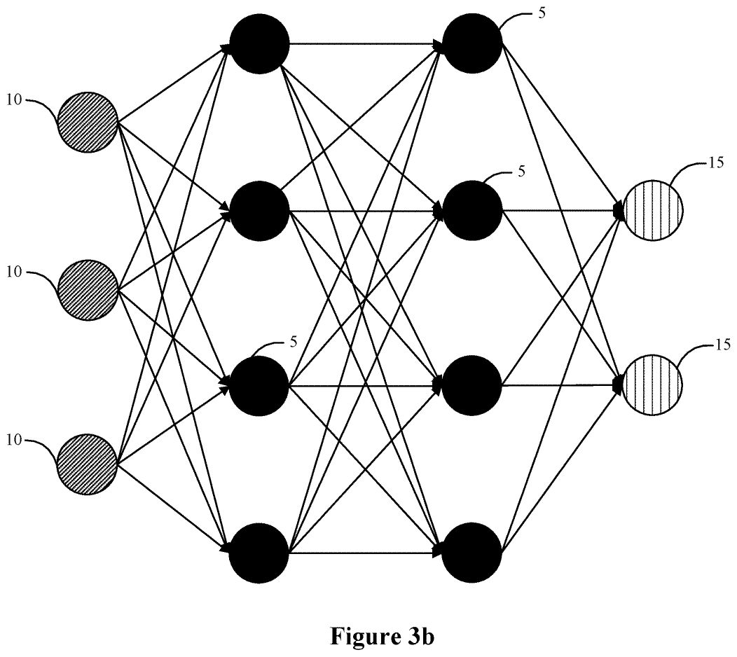

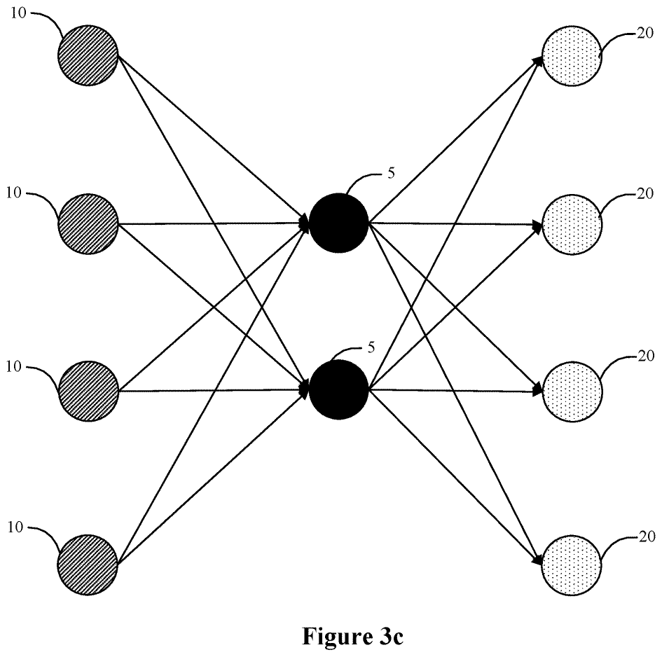

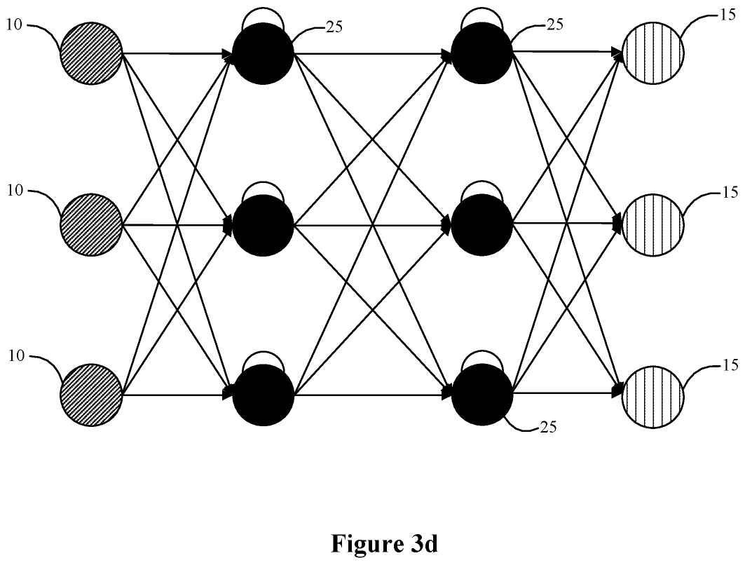

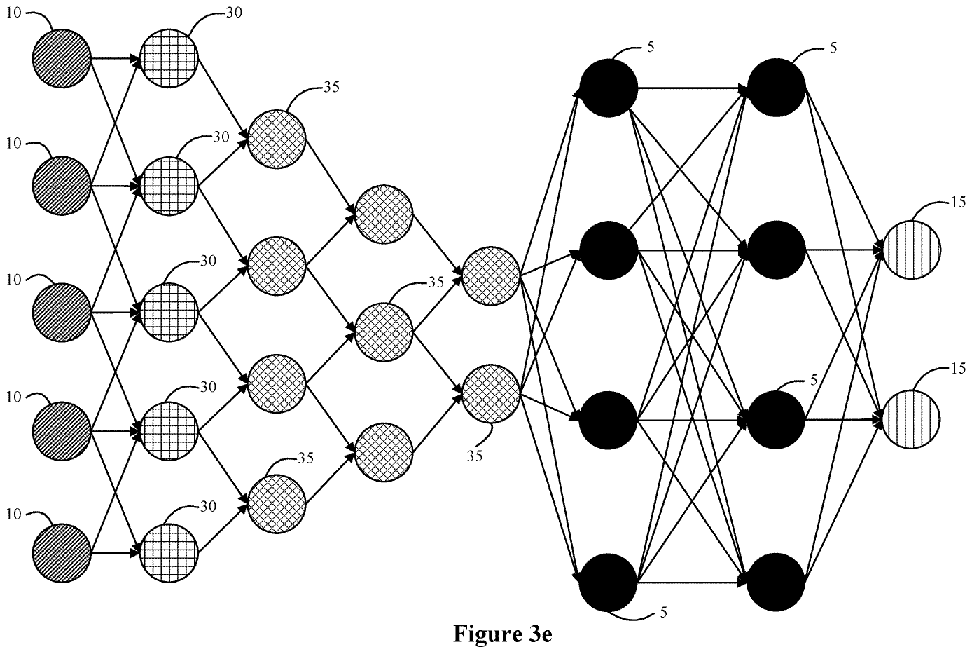

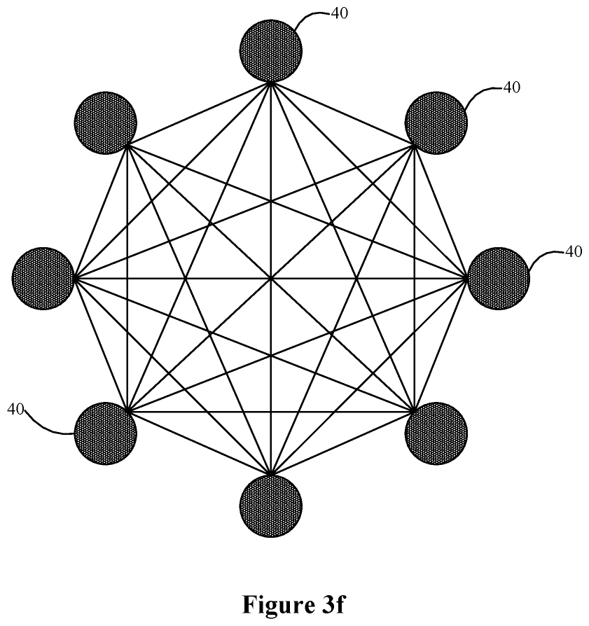

FIGS. 3a-f illustrate some of the many other network configurations that can be trained with the method described herein. FIG. 3a is a feed forward network made of two input cells 10, two hidden cells (the expressions “hidden cells” and “spiking neurons” 5 may be used interchangeably in the remainder of this description) and one output cell 15, FIG. 3b is a deep feed forward network made of three input cells 10, eight hidden cells 5 and two output cells 15, FIG. 3c is an auto encoder neural network made of four input cells 10, two hidden cells 5 and four match input output cells 20, FIG. 3d is a recurrent neural network made of three input cells 10, six recurrent spiking neurons or cells 25 and three output cells 15, FIG. 3e is a deep convolutional network made of five input cells 10, five kernel cells 30, nine convolution or pool neurons or cells 35, eight hidden cells 5 and three output cells 15 and FIG. 3f is a Hopfield network made of eight fully connected back fed spiking input neurons or cells 40.

### Training Method

Since spiking neural networks exploit the non-differentiable nature of spike events, the method suggested herein is gradient-free, i.e., it does not expect to access a value of a gradient of the error/loss function at any time during the training phase. In practice, this training method is based on two different components combined with each other: 1) a first (and main) pass is provided by a simulated annealing algorithm, and 2) a refinement pass is performed afterwards to eventually refine the solution found by the previous computational treatment.

### Simulated Annealing (SA)

In the earliest days of scientific computing, more precisely in 1953, Metropolis et al. introduced a simple algorithm that can be used to provide an efficient simulation of a collection of atoms in equilibrium at a given temperature in the paper entitled “Equation of State Calculations by Fast Computing Machines”. In each step of this algorithm, an atom is given a small random displacement and the resulting change, ΔE, in the energy of the system is computed. If ΔE≤0, the displacement of the atom is accepted, and the configuration with the displaced atom is used as the starting point of the next step. The case ΔE>0 is treated probabilistically: the probability that the configuration is accepted is P(ΔE)=exp(−ΔE k_{B}T), with k_{B} being the Boltzmann constant and Tan effective temperature. For simplicity, the product k_{B}T can be referred to as the effective temperature. Random numbers uniformly distributed in the interval [0, 1] are a convenient means of implementing the random part of the algorithm. One such number is selected and compared with P(ΔE). If it is less than P(ΔE), the new configuration is retained; if not, the original configuration is used to start the next step. By repeating the basic step many times, one eventually ends up simulating the thermal motion of atoms in thermal contact with a heat bath at temperature k_{B}T.

Now, using the error/cost function ƒ=ƒ({xᵢ}) in place of the physical energy function E=E({xᵢ}), and defining a configuration by a set of parameters {xᵢ}(represented, in this specific case, by the set of weights {wᵢ} in the network to be trained), a population of configurations/weights can be generated for the (optimization) problem consisting of finding the weights of the network at hand. In this context, the effective temperature k_{B}T is represented by a scalar which decreases linearly with the number of iterations from one (arbitrarily chosen) maximum value to a minimum value (arbitrarily chosen). See the pseudo-code below; for the values of the hyper-parameters, see the box further below.

For clarity, an example of pseudo-code for simulated annealing is presented below. The algorithm starts from a guess for the set of weights which, in this case, is selected randomly at the beginning of the training phase.

Simulated annealing algorithm

```
Assign random initial weights in the range [0,1] to the vector w₀
Initialize the parameters: Boltzmann's constant k_{B}, minimum and maximum
effective temperatures k_{B}Tmin and k_{B}Tmax, effective temperature k_{B}T, Δw
which defines a sub-space dimensions in which to search for a solution and m
which is a maximum number of iterations
while the desired accuracy is not reached do
  for mᵢ =0 to number of new solution m−1 to explore in the search space
      Select a new solution w₀+Δw
        if f(w₀+Δx) >f(w₀) then
          f_{new} = f (w₀ + Δw); w₀ = w₀ + Δw
        else
          Δf = f(w₀ + Δw) −f(w₀)
          random r(0, 1)
            if r > exp(−Δf /k_{B}T) then
              f_{new} = f(w₀ + Δw); w₀ = w₀ + Δw
            else
              f_{new} = f(w₀)
            end if
        end if
      f = f_{new}
      Decrease the temperature periodically: k_{B}T = k_{B}Tmax−mᵢ*(
    k_{B}Tmax− k_{B}Tmin)/(m−1)
  end for
end while
```

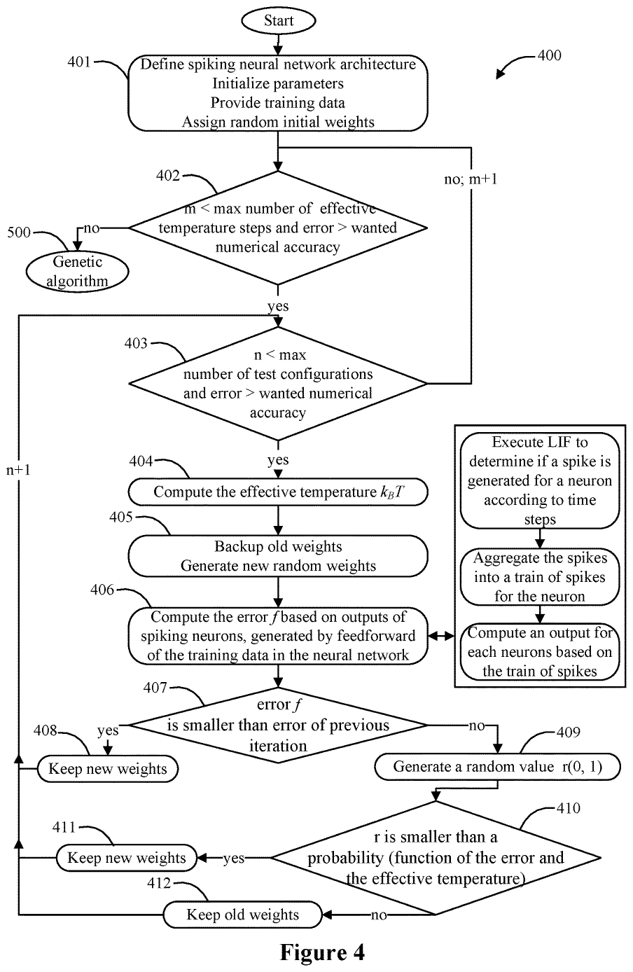

Turning to FIG. 4, the SA algorithm 400 is illustrated. The method starts by defining a spiking neural network architecture (refer to FIGS. 2 and 3 for different examples of architectures), initializing parameters, providing training data and assigning random initial weights to the connections of the neural network, 401. The random initial weights are in the range [0,1]. For a number m of effective temperature steps and until the error is greater than a wanted numerical accuracy, 402, and for a number n of test configurations and until the error is greater than a wanted numerical accuracy, 403, the following steps (404-412) are executed.

The effective temperature k_{B}T is computed, 403. The current weights in the network are backed up. New random weights are generated. The random weights may be generated in the vicinity of the (or in a search space around) the previous weights. The error of the network is computed, based on the outputs of the neurons generated from feedforward of the data in the neural network, 406. This step comprises executing the LIF method to determine if a spike is generated at a given time for each neuron, aggregating the spikes into a train of spikes for each neuron and computing an output for each neuron based on the generated train of spike. If should be understood that the output of many neurons may serve as input of hidden or output neurons. In that case, several trains of spikes may be input into the hidden or output neurons. These trains of spikes are, for example, stochastically combined so to merge into a single train of spikes to serve as input to the hidden or output neurons. More specifically, the weights are used to decided what (input) spike to select when two or more are overlapping—i.e., they are selected according to the value of the weight which now represent a probability. It should be understood that the merging of a plurality of trains of spikes into a single train of spikes may be done in different manners.

If the error is smaller than the error of the previous iteration, 407, the new weights are kept, 408. If not, a random value between 0 and 1 is generated, 409. If the random value is smaller than a probability (which is a function of the error and the effective temperature), 410, then the new weights are kept, 411, otherwise the old weights are recuperated from backup, 412.

For the specific problem of training recurrent spiking neural networks, due to the stochastic way the weights are treated (as described above), the error function is computed as an average of the usual L2 norm (or Root Mean Square Error (RMSE) function). By means of numerical experiments, it is possible to observe that this improves the speed of the convergence during the training phase.

### Genetic Algorithm

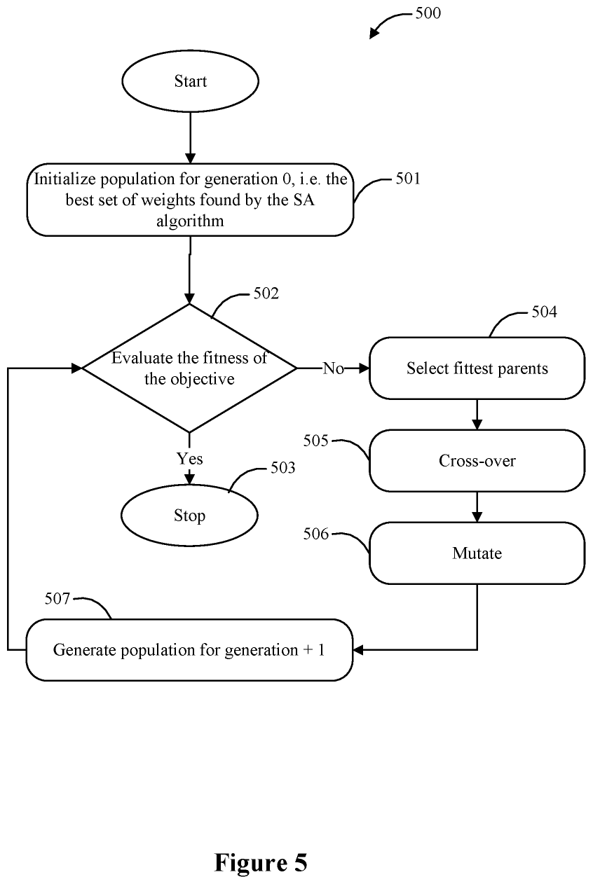

At the end of the simulated annealing search, a final pass to improve the accuracy of the solution (found by the SA method) is performed by means of a standard genetic algorithm refinement, illustrated in FIG. 5, where the best solution found by the SA method is improved by using it as the initial conditions of the genetic algorithm itself. This final step/pass is of relevance since it effectively improves the accuracy of the solution found by means of the SA method (which precision can be affected by many different reasons, e.g., the introduced discretization).

Turning to FIG. 5, at the beginning of the genetic algorithm 500, a population of weights is initialized, step 501, which corresponds to the set of weights found by the previously applied SA method. The weights in the set of weights are randomly modified (i.e., mutated) to create an ensemble of such sets of weights (i.e., a population). Then an evaluation of the fitness of this population is obtained, step 502, by computing the error/cost corresponding to every set of weights of the population. If one set of weights in the population has a corresponding error which meets the criterion to stop the algorithm, step 503, (in the present case if the error/cost is lower than a specified value F), then that set of weights represents the final solution. In the negative case, the best elements of the population are selected, step 504, and mutated (represented by the phases “cross-over”, step 505, and “mutate”, step 506, in the diagram). This algorithm is repeated after generating the population for the next generation, step 507, until a solution which meets the selection criterion is met.

### Results

A selected list of simple numerical experiments is described below to illustrate how the training method works. These experiments consist of curve fitting problems for 1) a linear function, 2) a square root function, 3) a quadratic function and, finally, 4) a classification problem for a scaled down MNIST dataset.

The MNIST dataset is down scaled to a resolution equal to 9×9. Consequently, the specific architecture utilized consists of three layers, i.e., one input, one hidden and one output layer, where the input layer has 81 neurons, the hidden layer has 32 neurons and the output layer has 10 neurons, with feedforward and feedback connections, but no contextual connections.

While the linear, square root and quadratic functions are one-dimensional functions, they represent archetypal problems in machine learning, and they also provide a simple and comprehensible playground to test the method. At the same time, the small non-linearities of these curves allow to keep the neural networks relatively simple. The MNIST dataset provides a more complex case which highlight the classification capabilities of such networks.

All networks tested, for the curve fitting tests, have one input and one output neuron while, in the middle layers, they have a variable number of layers and neurons. In details, they consist of one of the following architectures: 1×2×2×1, 1×2×2×2×1, 1×2×2×2×2×1, 1×2×2×2×2×2×1, 1×3×3×3×1, 1×4×4×4×4×1 and 1×5×5×5×5×5×1 (in other words, these are deep recurrent spiking neural networks). The network for the scaled down MNIST problem has the architecture: 81×32×10.

Examples of hyper-parameters in use for the numerical experiments are presented below.

TF=1.; // final time
AVERAGE=128; // number of inferences to compute the average
MMAX=32; // SA - outer loop - number of effective temperature steps
NMAX=16; // SA - inner loop - number of test configurations
KBTMIN=1.e−4; // SA - effective temperature minimum
KBTMAX=8.; // SA - effective temperature maximum
EPS=0.01; // SA - final accuracy
NUM_POPULATION=64; // GA - tot. num. of random elements created
at every step
NUM_STEPS=32; // GA - tot. num. of steps for the classical search
GA_R0=0.1; // GA - initial radius
GA_EPS=0.01; // GA - numerical accuracy
SCALE=10.; // scaling factor for the output spikes
SHIFT=70.; // shift factor for the output spikes
BASE=2.; // base for the output spikes

TF is the total time for the simulation of the neural networks described previously, i.e., the final time of the LIF model.

AVERAGE is the number of inferences required by the network to make an average of the error/cost function (see above for more details).

MMAX and NMAX are the parameters for the SA method which specify the total number of iterations (or annealing steps) and the total number of trials per iteration respectively.

KBTMIN and KBTMAX are the parameters for the SA method which specify the annealing schedule (arbitrary units). In this case, it is a linear annealing schedule which starts from KBTMIN and ends to KBTMAX in NMAX iterations.

EPS is the final accuracy to reach by means of the SA method (arbitrary units). If the error/cost function reaches a value smaller than EPS then the training phase based on the SA method stops.

NUM_STEPS and NUM_POPULATION refer to total number of steps and the number of off-springs (cross-over+mutation) for the genetic algorithm, illustrated in FIG. 5.

GA_R0 is a value specifying the space of solution to explore during a genetic pass 500 (in other words, this is the space in which new elements of the population are created). At every iteration, this space consists in a multi-dimensional sphere with a center and radius. The algorithm starts from an initial guess for the center and randomly selects candidate solutions around the initial guess in a spherical domain with initial radius GA_R0. At each iteration step of the genetic algorithm, the radius is reduced according to the formula:

$$radius = GA\_R0 \times ( 1 - m / M )$$

where m is the current iteration number (ranging from 0 to M) and M is the total number of iterations. Finally, the variable GA_EPS represents the final accuracy to reach for the genetic algorithm (i.e., if the error/cost function is lower than GA_EPS then the best solution is found, and the algorithm stops).

To conclude, the variables SCALE, SHIFT and BASE allow the spiking neural network to perform inferences. In particular, the network provides (through its output neuron) a train of spikes which needs to be interpreted to provide a meaningful inference. Therefore, a counter is connected to the last neuron, i.e., a neuron (or device) which counts the total number of spikes in a given train of spikes. If the total number of spikes during the i-th trial is indicated with Nᵢ, then the inference is performed by using the following formulas (in pseudo-code):

Z = 0
For i in range (0, number_of_samples): Z = Z +
(i-th_neuron_output − SHIFT) / SCALE
Z = Z / number_of_samples
final inference = pow(BASE, Z)

In the pseudocode above, a generalization to obtain negative numbers as well is easily introduced by shifting the value Z.

Below, the actual numerical experiments are presented.

### Curve Fitting Tests

Two sets of tests are presented in this section, where three points are provided x₁[0.2,ƒ(0.2)], x₂[0.6,ƒ(0.6)] and x₃[0.8,ƒ(0.8)] with the function ƒ(x)=x in the first set, ƒ(x)=sqrt(x) in the second set and ƒ(x)=x² in the third set (i.e., two convex and one concave non-linear functions). A network is trained on these points and the training is interrupted, successively, when the cost function attains values equal (or very close to) 0.15, 0.10, 0.05 and 0.01. Then, the quality of the network and its learning pace is assessed by comparing the inferences of the network with the original points for every interruption of the training phase. In this context, it is expected that if the network is learning fast enough, its predictions should be close to the original data (at least qualitatively) even at the very earliest interruptions.

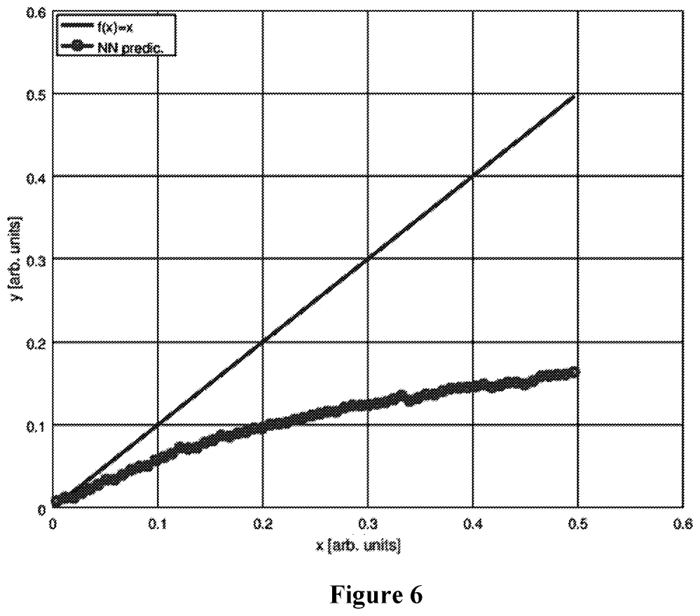

The first network tested in this section is represented by a 1×2×2×1 network depicted in FIG. 2. The results are presented in FIGS. 6-9 and 10-13. A visual inspection seems to indicate that the SNN learns the shape of the curve for the data relatively rapidly.

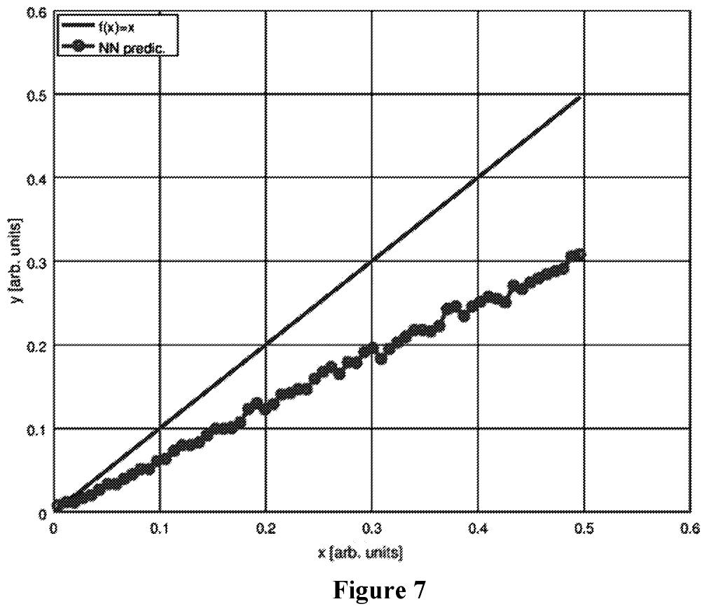

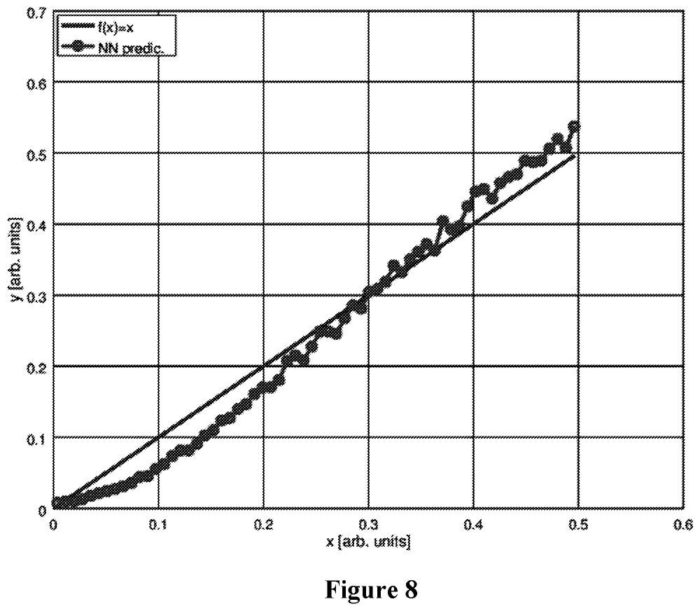

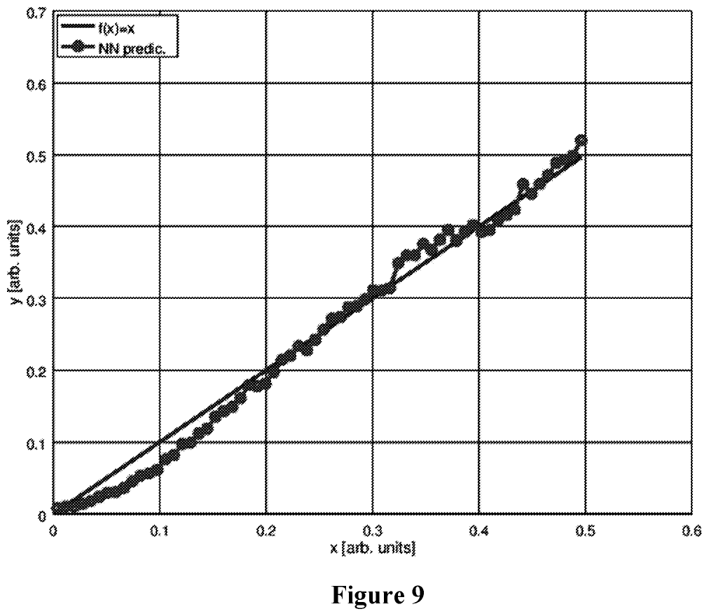

FIGS. 6-9 are graphs illustrating results obtained using a 1×2×2×1 network according to FIG. 2 for fitting the function f(x)=x. FIGS. 6 to 9 correspond, respectively, to error/cost functions with values 0.15 (FIG. 6), 0.10 (FIG. 7), 0.05 (FIG. 8) and 0.01 (FIG. 9).

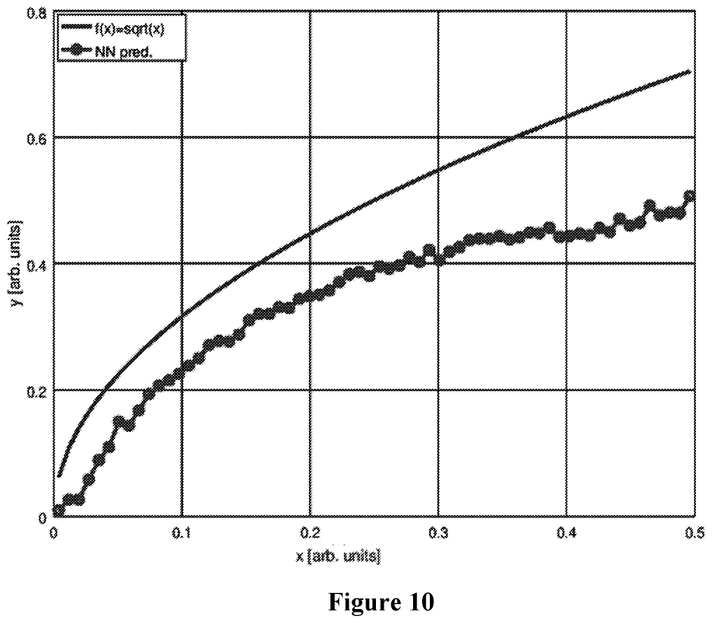

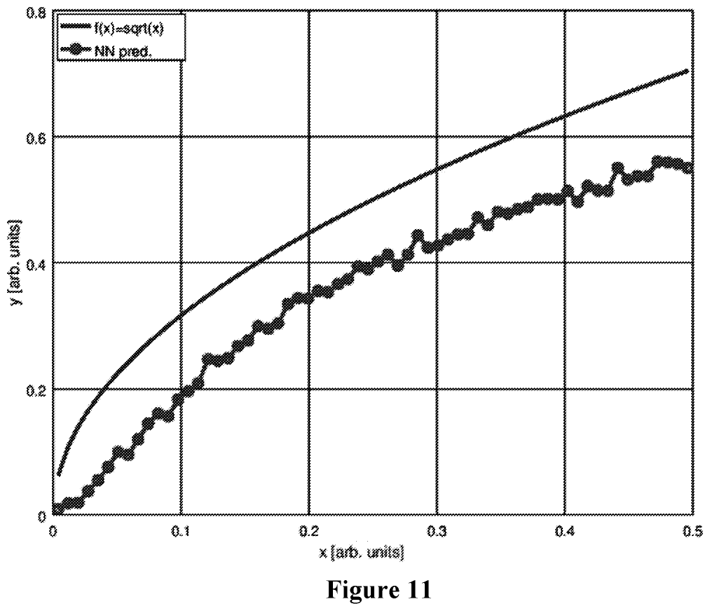

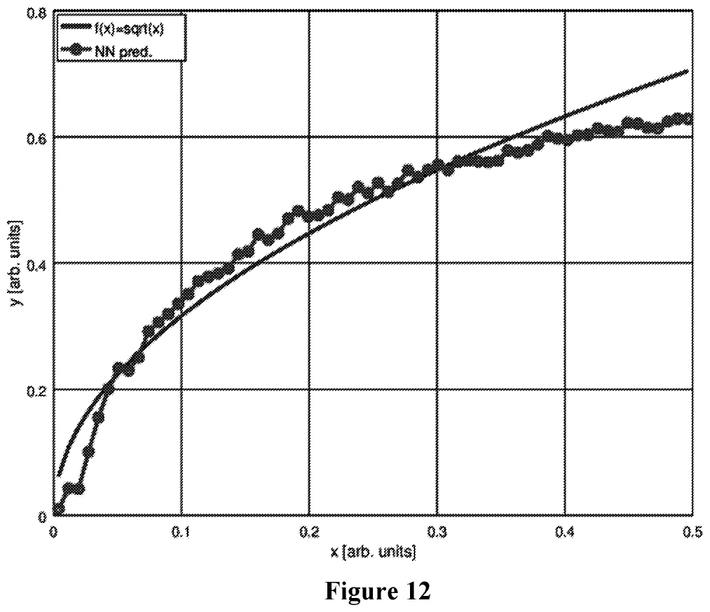

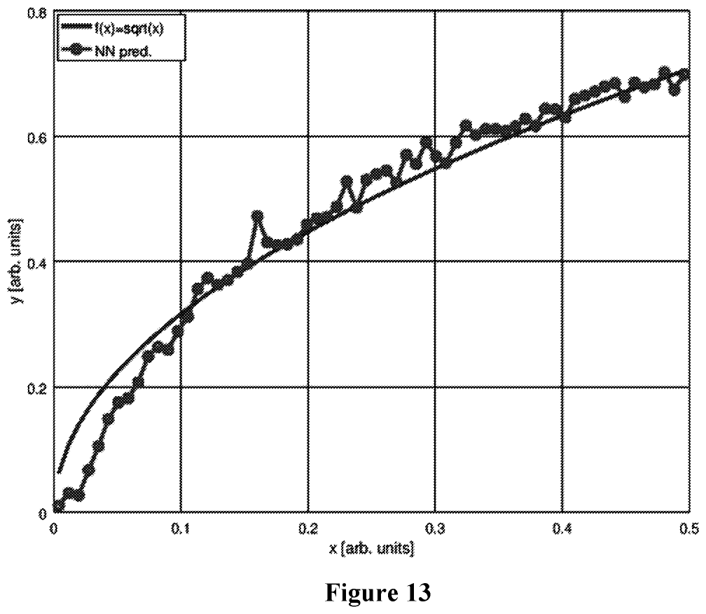

FIGS. 10-13 are graphs illustrating results obtained using a 1×2×2×1 network according to FIG. 2 for fitting the function f(x)=sgrt(x). FIGS. 10 to 13 correspond, respectively, to error/cost functions with values 0.15 (FIG. 10), 0.10 (FIG. 11), 0.05 (FIG. 12) and 0.01 (FIG. 13).

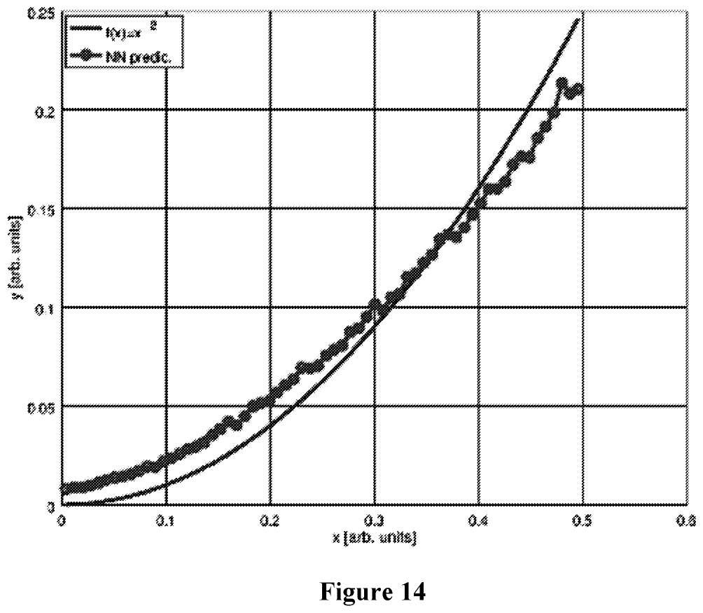

A second series of numerical experiments is performed which still consists in the curve fitting problem but for the function ƒ(x)=x², and on the same three x-positions encountered in the previous section (i.e., x=0.2, x=0.6, and x=0.8). FIGS. 14-16 show the results obtained for 1×2×2×1, 1×2×2×2×1 and 1×2×2×2×2×1 neural networks which follow the connection unit of FIG. 1 and with accuracy equal to or smaller than 0.01.

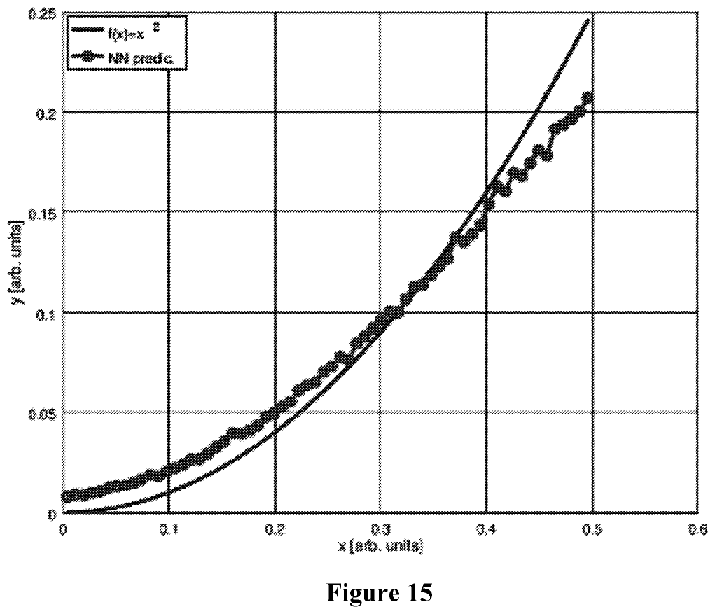

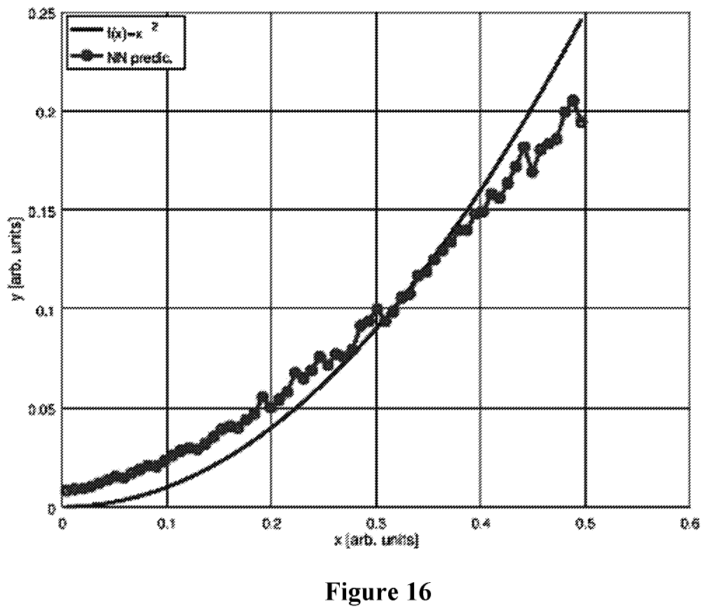

FIGS. 14-16 are graphs illustrating results obtained for fitting the quadratic function f(x)=x² using different network configurations. FIGS. 14 to 16 use, respectively, the following networks configurations: 1×2×2×1 (FIG. 14), 1×3×3×1 (FIG. 15) and 1×4×4×1 (FIG. 16).

Other network architectures have been tested as well reaching the following results in the table below (with meaningful results):

| network architecture | EPS | accuracy reached |
|---|---|---|
| 1 × 2 × 2 × 1 | 0.01 | 0.00884636 |
| 1 × 2 × 2 × 2 × 1 | 0.01 | 0.00856304 |
| 1 × 2 × 2 × 2 × 2 × 1 | 0.01 | 0.01007690 |
| 1 × 2 × 2 × 2 × 2 × 2 × 1 | 0.01 | 0.00962734 |
| 1 × 3 × 3 × 3 × 1 | 0.01 | 0.00997261 |
| 1 × 4 × 4 × 4 × 4 × 1 | 0.01 | 0.00964278 |
| 1 × 5 × 5 × 5 × 5 × 5 × 1 | 0.01 | 0.00897368 |

The proposed training method suggested in this document can solve the curve fitting problem with a variety of different curves and for different deep, recurrent, spiking neural networks.

### Scaled Down MNIST Test

The MNIST dataset is a large database of handwritten digits, from 0 to 9, that is commonly used for training and testing in the field of ML. The MNIST database contains 60,000 training images and 10,000 testing images. Every item in this dataset is represented by a grey scale image with a resolution equal to 28×28 pixels.

To make the test performed in this section computationally less demanding, every image of the dataset is down scaled to a resolution equal to 9×9. The strategy to down scale is quite simple and consists in computing the value of the 9×9 image by averaging the values of a 3×3 area over the corresponding 28×28 image (this is a standard procedure followed by other approaches published in the field of ML).

The network trained over the MNIST dataset consists of a recurrent, deep, spiking neural network with architecture 81×32×10, i.e., 81 neurons in the input layer, 32 neurons in hidden layer and 10 neurons in the output layer connected by means of feedforward and feedback connections. Here, deep means the neural network comprises more than one layer and recurrent means the neural network has feedback connections. The strategy used to make a classification is the so-called winner-take-all, i.e., the neuron in the output layer which has more spikes represents the corresponding digit (there are 10 output neurons with each corresponding to one specific digit).

The best accuracy obtained by this architecture, trained by the method suggested in this work, is reported in the table below:

| Dataset | architecture | accuracy reached |
|---|---|---|
| MNIST | 81 × 20 × 10 | 95.83 |

This test shows that it is possible to train deep recurrent spiking neural networks for more complex learning tasks (in this case, a classification test) by using the method suggested in this document.

It should be noted that methods and steps described herein are, generally, computer implemented methods and steps. The term computer may be interpreted as having different meanings, such as explained further below, for example.

Referring again to FIG. 1, there is provided an artificial spiking neural network building block 50. The artificial spiking neural network building block 50 includes two layers. The layers are the vertical arrangements of neurons 5. Layer includes two spiking neurons 5. Each spiking neuron comprise at least one feedback input connection, operative to receive spikes from at least one spiking neuron of a subsequent layer. In the figure this is illustrated by an arrow with a “feedback” label. The feedback goes from one spiking neuron of a subsequent layer (to the right of the arrow in the figure) towards one spiking neuron of a previous later (to the left of the arrow in the figure). One feedback connection serves as an input to a preceding layer and as an output to a subsequent layer. In the case where the artificial spiking neural network building block 50 is connected to an input neuron and an output neuron, as in FIG. 2a, some arrows are missing. The same principles apply to “feedforward” and “contextual” information. Each spiking neuron is operative to receive full feedback, transmit full feedforward and transmit/receive full contextual information, but depending on the architecture of the spiking neural network, some arrows will be missing and such feedback, feedforward and/or contextual may or may not be sent/received.

Each spiking neuron comprises at least one feedback output connection, operative to transmit spikes to at least one spiking neuron of a preceding layer. Each spiking neuron comprises at least one feedforward input connection, operative to receive spikes from at least one spiking neuron of the preceding layer. Each spiking neuron comprises at least one feedforward output connection, operative to transmit spikes, from the spiking neuron, to at least one spiking neuron of the subsequent layer. Each spiking neuron comprises at least one contextual input connection, operative to receive spikes from at least one spiking neuron of a same layer. Each spiking neuron comprises at least one contextual output connection, operative to transmit spikes to at least one spiking neuron of the same layer. The input and output connections between the spiking neurons are operative to transmit or receive trains of spikes.

A response of each spiking neuron may be modeled using a discretized method to simulate the leaky fire-and-integrate model (LIF). The discretized method may comprise computing

$${y}^{n + 1} = {y}^{n} + Δ t \cdot ( - ( {y}^{n} - {y}_{rest} ) + refactory\_period * R * I ( 0 ) ) / {τ}_{m} ,$$

where y is a searched solution,
n indicates an iteration number;
Δt is a time step for a simulation;
yᵣₑₛₜ is a membrane potential at rest, when no spike is produced, refractory period is a recovery time for an excitable neuron membrane to be ready for a subsequent stimulus,
R is an internal resistance of a neuron, and
τₘ is a neuron membrane time constant.

FIGS. 2a-d illustrate some of the possible models of spiking neural networks. A spiking neural network comprises at least one input spiking neuron, at least one output spiking neuron, and at least one spiking neural network building block, as described previously, connected between the at least one input spiking neuron and the at least one output spiking neuron via feedforward connections.

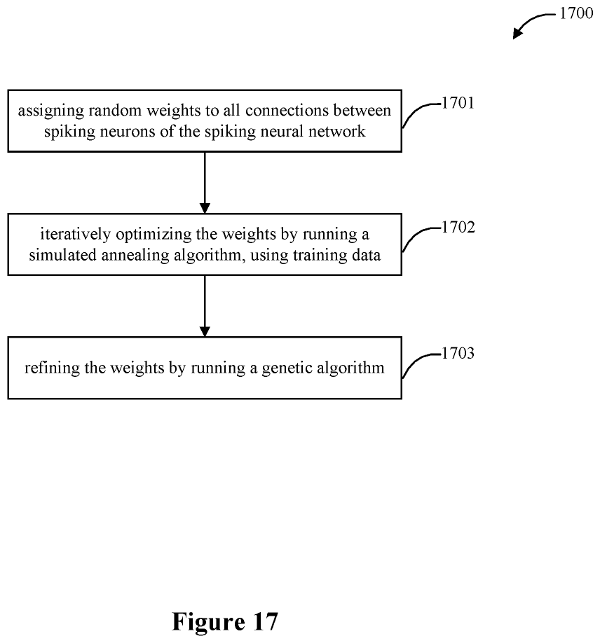

Turning to FIG. 17, there is provided a computer implemented method 1700 for training a spiking neural network. The method comprises assigning, step 1701, random weights to all connections between spiking neurons of the spiking neural network. The method comprises iteratively optimizing, step 1702, the weights by running a simulated annealing algorithm, using training data. The method comprises refining, step 1703, the weights by running a genetic algorithm.

The method can apply to training any types or configurations of spiking neural networks comprising any number of spiking neurons. FIGS. 3a-f, provide some examples of spiking neural networks that could be trained using the method 1700.

The method may further comprise initializing parameters of the simulated annealing algorithm. The parameters include a maximum effective temperature, a minimum effective temperature, a maximum number of effective temperature steps, a wanted numerical accuracy, and a maximum number of test configurations.

The simulated annealing algorithm may comprise computing an effective temperature k_{B}T, generating new random weights, computing an error ƒ based on outputs of the spiking neurons generated by feedforward of the training data in the spiking neural network, using the new random weights, and deciding to keep or discard the new random weights based on the computed error ƒ, an error obtained with previous weights and the effective temperature k_{B}T.

k_{B}T may be computed using k_{B}T k_{B}Tmax−mᵢ*(k_{B}Tmax−k_{B}Tmin)/(m−1), where k_{B}Tmax is the maximum effective temperature, k_{B}Twin is the minimum effective temperature and m is a counter indicating a current iteration of the simulated annealing algorithm.

The weights may have values comprised between zero and one.

The error ƒ may be computed by comparing an output of the spiking neural network, with an output expected for the training data.

The output of the spiking neural network may be obtained by simulating responses of each spiking neuron modeled using a discretized method to simulate the leaky fire-and-integrate model (LIF).

The discretized method may comprise computing

$${y}^{n + 1} = {y}^{n} + Δ t \cdot ( - ( {y}^{n} - {y}_{rest} ) + refactory\_period * R * I ( 0 ) ) / {τ}_{m} ,$$

where y is a searched solution,
n indicates an iteration number;
Δt is a time step for a simulation;
yᵣₑₛₜ is a membrane potential at rest, when no spike is produced, refractory period is a recovery time for an excitable neuron membrane to be ready for a subsequent stimulus,
R is an internal resistance of a neuron, and
τₘ is a neuron membrane time constant.

Deciding to keep or discard the new random weights may comprises executing the following. If the error ƒ is smaller than the error obtained with previous weights, keep the new random weights. Else, generate a random value between zero and one, if the random value is smaller than a probability that is a function of the error and the effective temperature, keep the new random weights. Else keep the old weights.

The probability may be computed using P(ΔE)=exp(−ΔE k_{B}T), where ΔE is a difference between the error ƒ and the error obtained with previous weights.

The method may be executed until the maximum number of test configurations are explored for each of the number of effective temperature steps or until the wanted numerical accuracy is reached.

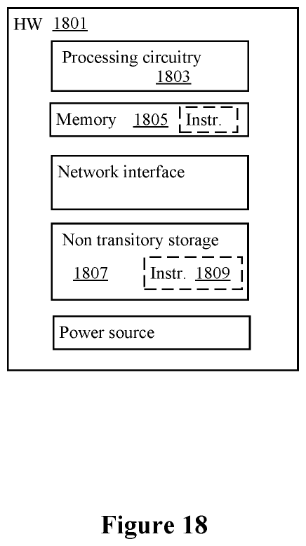

Referring to FIG. 18, there is provided an apparatus (HW) 1801, in which functions and steps described herein can be implemented.

The apparatus 1801 (which may go beyond what is illustrated in FIG. 18), may be a user device, such as a smartphone, tablet, computer, wearable, connected vehicle, etc.

The apparatus 1801 may be a server, network node, radio base station, or other computing device which may be part of a cloud computing system, edge computing system, or which may be a standalone device.

The apparatus 1801 may be an internet of things (IoT) device.

The apparatus is operative to train a spiking neural network according to the different steps described herein. It may be operative to distribute the trained spiking neural network, update the spiking neural network, make inferences using the spiking neural network, etc.

The apparatus 1801 comprises processing circuitry 1803 and memory 1805. The memory 1805 can contain instructions executable by the processing circuitry 1803 whereby functions and steps described herein may be executed to provide any of the relevant features and benefits disclosed herein.

The apparatus 1801 may also include non-transitory, persistent, machine-readable storage media 1807 having stored therein software and/or instruction 1809 executable by the processing circuitry 1803 to execute functions and steps described herein. The apparatus may also include network interface(s) and a power source.

The instructions 1809 may include a computer program for configuring the processing circuitry 1803. The computer program may be stored in a physical memory local to the device, which can be removable, or it could alternatively, or in part, be stored in the cloud. The computer program may also be embodied in a carrier such as an electronic signal, optical signal, radio signal, or computer readable storage medium.

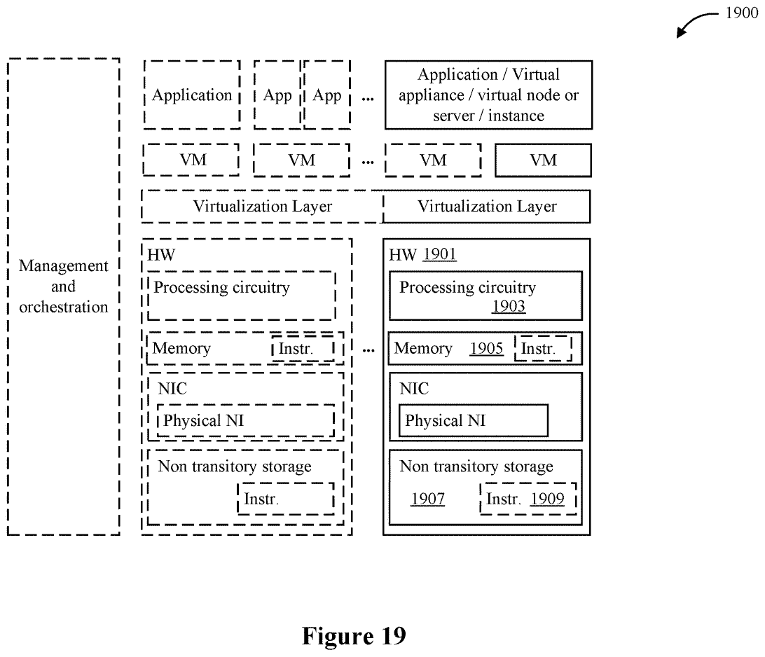

Referring to FIG. 19, there is provided a virtualization environment 1900 in which functions and steps described herein can be implemented.

The virtualization environment 1900 (which may go beyond what is illustrated in FIG. 19), may comprise systems, networks, servers, nodes, devices, etc., that are in communication with each other either through wire or wirelessly, e.g., through a network interface component (NIC) comprising physical network interface(s). Some or all of the functions and steps described herein may be implemented as one or more virtual components (e.g., via one or more applications, components, functions, virtual machines, containers, etc.) executing on one or more physical apparatus in one or more networks, systems, environment, etc.

A virtualization environment provides hardware 1901 comprising processing circuitry 1903 and memory 1905. The memory 1905 can contain instructions executable by the processing circuitry 1903 whereby functions and steps described herein may be executed to provide any of the relevant features and benefits disclosed herein.

The hardware 1901 may also include non-transitory, persistent, machine-readable storage media 1907 having stored therein software and/or instruction 1909 executable by the processing circuitry 1903 to execute functions and steps described herein.

The instructions 1909 may include a computer program for configuring the processing circuitry 1903. The computer program may be stored in a removable memory, such as a portable compact disc, portable digital video disc, or other removable media. The computer program may be stored in a physical memory local to the hardware 1901, which can be removable, or it could alternatively, or in part, be stored in the cloud. The computer program may also be embodied in a carrier such as an electronic signal, optical signal, radio signal, or computer readable storage medium.

Referring to FIGS. 18 and 19, there is provided an apparatus 1801, 1901, operative to train a spiking neural network. The apparatus comprises processing circuits 1803, 1903 and a memory 1805, 1905. The memory containing instructions executable by the processing circuits. The apparatus is operative to assign random initial weights to all connections between spiking neurons of the spiking neural network. The apparatus is operative to iteratively optimize the weights by running a simulated annealing algorithm, using training data. The apparatus is operative to refine the weights by running a genetic algorithm.

The apparatus is further operative to execute any of the steps described herein.

There is also provided a non-transitory computer readable media 1807, 1907 having stored thereon instructions 1809, 1909 for training a spiking neural network. The instructions comprise assigning random initial weights to all connections between spiking neurons of the spiking neural network. The instructions comprise iteratively optimizing the weights by running a simulated annealing algorithm, using training data. The instructions comprise refining the weights by running a genetic algorithm.

The non-transitory computer readable media further comprises instructions for executing any of the steps described herein.

Modifications will come to mind to one skilled in the art having the benefit of the teachings presented in the foregoing description and the associated drawings. Therefore, it is to be understood that modifications, such as specific forms other than those described above, are intended to be included within the scope of this disclosure. The previous description is merely illustrative and should not be considered restrictive in any way. The scope sought is given by the appended claims, rather than the preceding description, and all variations and equivalents that fall within the range of the claims are intended to be embraced therein. Although specific terms may be employed herein, they are used in a generic and descriptive sense only and not for purposes of limitation.

1. An artificial spiking neural network building block, comprising:
two layers, each comprising two spiking neurons;
each spiking neuron comprising:
at least one feedback input connection, operative to receive spikes from at least one spiking neuron of a subsequent layer;
at least one feedback output connection, operative to transmit spikes to at least one spiking neuron of a preceding layer;
at least one feedforward input connection, operative to receive spikes from at least one spiking neuron of the preceding layer;
at least one feedforward output connection, operative to transmit spikes, from the spiking neuron, to at least one spiking neuron of the subsequent layer;
at least one contextual input connection, operative to receive spikes from at least one spiking neuron of a same layer; and
at least one contextual output connection, operative to transmit spikes to at least one spiking neuron of the same layer.

2. The artificial spiking neural network building block of claim 1, wherein a response of each spiking neuron is modeled using a discretized method to simulate the leaky fire-and-integrate model (LIF).

3. The artificial spiking neural network building block of claim 2, wherein the discretized method comprises computing
$${y}^{n + 1} = {y}^{n} + Δ t \cdot ( - ( {y}^{n} - {y}_{rest} ) + refactory\_period * R * I ( 0 ) ) / {τ}_{m} ,$$
where y is a searched solution,
n indicates an iteration number;
Δt is a time step for a simulation;
yᵣₑₛₜ is a membrane potential at rest, when no spike is produced, refractory period is a recovery time for an excitable neuron membrane to be ready for a subsequent stimulus,
R is an internal resistance of a neuron, and
τₘ is a neuron membrane time constant.

4. A spiking neural network comprising:
at least one input spiking neuron;
at least one output spiking neuron; and
at least one spiking neural network building block according to claim 1, connected between the at least one input spiking neuron and the at least one output spiking neuron via feedforward connections.

5. A computer implemented method for training a spiking neural network, comprising:
assigning random weights to all connections between spiking neurons of the spiking neural network;
iteratively optimizing the weights by running a simulated annealing algorithm, using training data; and
refining the weights by running a genetic algorithm.

6. The method of claim 5, further comprising initializing parameters of the simulated annealing algorithm, the parameters including:
a maximum effective temperature;
a minimum effective temperature;
a maximum number of effective temperature steps;
a wanted numerical accuracy; and
a maximum number of test configurations.

7. The method of claim 6, wherein the simulated annealing algorithm comprises:
computing an effective temperature k_{B}T;
generating new random weights;
computing an error ƒ based on outputs of the spiking neurons generated by feedforward of the training data in the spiking neural network, using the new random weights; and
deciding to keep or discard the new random weights based on the computed error ƒ, an error obtained with previous weights and the effective temperature k_{B}T.

8. The method of claim 7, wherein k_{B}Tis computed using k_{B}T=k_{B}Tmax−mᵢ*(k_{B}Tmax−k_{B}Tmin)/(m−1), where k_{B}Tmax is the maximum effective temperature, k_{B}Tmin is the minimum effective temperature and m is a counter indicating a current iteration of the simulated annealing algorithm.

9. The method of claim 7, wherein the weights have values comprised between zero and one.

10. The method of claim 7, wherein the error ƒ is computed by comparing an output of the spiking neural network, with an output expected for the training data.

11. The method of claim 10, wherein the output of the spiking neural network is obtained by simulating responses of each spiking neuron modeled using a discretized method to simulate the leaky fire-and-integrate model (LIF).

12. The method of claim 11, wherein the discretized method comprises computing
$${y}^{n + 1} = {y}^{n} + Δ t \cdot ( - ( {y}^{n} - {y}_{rest} ) + refactory\_period * R * I ( 0 ) ) / {τ}_{m} ,$$
where y is a searched solution,
n indicates an iteration number;
Δt is a time step for a simulation;
yᵣₑₛₜ is a membrane potential at rest, when no spike is produced,
refractory period is a recovery time for an excitable neuron membrane to be ready for a subsequent stimulus,
R is an internal resistance of a neuron, and
τₘ is a neuron membrane time constant.

13. The method of claim 7, wherein deciding to keep or discard the new random weights comprises:
if the error ƒ is smaller than the error obtained with previous weights, keep the new random weights;
else, generate a random value between zero and one, if the random value is smaller than a probability that is a function of the error and the effective temperature, keep the new random weights; and
else keep the old weights.

14. The method of claim 13, wherein the probability is computed using P(ΔE)=exp(−ΔE/k_{B}T), where ΔE is a difference between the error ƒ and the error obtained with previous weights.

15. The method of claim 7, wherein the method is executed until the maximum number of test configurations are explored for each of the number of effective temperature steps or until the wanted numerical accuracy is reached.

16. An apparatus, operative to train a spiking neural network, comprising processing circuits and a memory, the memory containing instructions executable by the processing circuits whereby the apparatus is operative to:
assign random initial weights to all connections between spiking neurons of the spiking neural network;
iteratively optimize the weights by running a simulated annealing algorithm, using training data; and
refine the weights by running a genetic algorithm.

17. (canceled)

18. (canceled)

19. (canceled)
